(19) United States
(12) Patent Application Publication
(10) Pub. No.: US 2004/0266885 A1
(43) Pub. Date: Dec. 30, 2004

(54) Wood preservative compositions

(76) Inventor: Jossef Gohary, Meitar (IL)

Correspondence Address: LERNER, DAVID, LITTENBERG,, KRUMHOLZ & MENTLIK, 600 SOUTH AVENUE WEST, WESTFIELD, NJ, 07090, US

(21) Appl. No.: 10/484,402

(22) PCT Filed: Jul. 4, 2002
(86) PCT No.: PCT/IL02/00545

(30) Foreign Application Priority Data
Jul. 26, 2001 (IL) 144608

(51) Int. Cl. A01N 41/10; A01N 31/08

(52) U.S. Cl. 514/709; 514/735

(57) ABSTRACT

An insecticidal and termiticidal wood preservative composition contains as an active ingredient a compound of the formula: (I) wherein Y is a moiety selected from halogen, substituted aromatic ring and/or aliphatic residue, and n=1 to 4.

### FIELD OF THE INVENTION

The present invention relates to the preservation of wood products. More specifically, the invention relates to the preservation of wood products from the attack of termites.

### BACKGROUND OF THE INVENTION

The preservation of timber against the attack of termites and other insect pests is a major undertaking because of the great damage inflicted by insects to stored timber and to wood and wood products, e.g., wood that is part of buildings or outdoor constructions.

Bromophenols have not been used in order to protect wood products from termites. One preferred illustrative compound of this class is Tetrabromobisphenol A (hereinafter referred to as “TBBA”) which is a fire-retardant material, widely employed for protecting plastics against fire. JP 61-6769 (Publication No. 55-159915) discloses the coating of a single wood plate with TBBA as a protection against mould.

It is an object of the present invention to provide a family of brominated phenols that can be used for protecting wood and wood products against insect attack, particularly against termites.

It is another object of the invention to provide solutions of insecticidal and termiticidal bromophenols that can be used to impregnate wood or wood products.

Other purposes and advantages of the invention will appear as the description proceeds.

### SUMMARY OF THE INVENTION

The invention is directed to an insecticidal and termiticidal wood preservative composition containing as an active ingredient a compound of the formula:

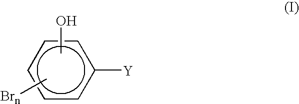

wherein Y is a moiety selected from halogen, substituted aromatic ring and/or aliphatic residue, and n-1 to 4.

A preferred class of compounds useful in the composition of the invention in that in which Y is

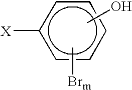

wherein X is a moiety selected from alkylidene, NH, S or SO₂, and m=0 to 4.

According to a preferred embodiment of the invention the compound of Formula (I) is selected from among tetrabromobisphenol A (TBBA), tribromobisphenol A (TBA), or a bromine derivative of a compound selected from Bisphenol F, Bisphenol A, Bisphenol S, Bisphenol Z, 4,4′-Biphenol, 1,1,2,2-tetra-(4-hydroxyphenyl) ethane, 2,2-hexafluoroisopropylidenediphenol, 1,1-ethylidenediphenol, 1,1-propylidenediphenol, or

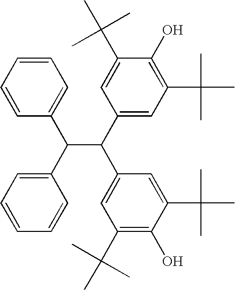

The insecticidal and termiticidal composition of the invention is conveniently dissolved in a solvent prior to impregnation into the wood. Different solvents are suitable for this purpose. Illustrative and non-limitative preferred solvents are ethanol and aqueous basic solutions, e.g., in which the base is NaOH.

According to a preferred embodiment of the invention the active material is TBBA and its concentration ranges between 1% (w/w) and 20% (w/w), preferably between about 3% and 10%.

The composition of the invention may further comprise conventional termiticidal and insecticidal agents which are well known to the skilled person.

In another aspect the invention is directed to a method for protecting wood against termites, comprising impregnating the wood with a wood preservative composition as described above. The term “protection”, as used herein, includes both the repulsion of termites away from the wood, and the actual killing thereof.

The present invention provides for a long-term protection of wood and wood products against termites by impregnating, e.g., by pressure-impregnation, the wood with an active ingredient, e.g. TBBA, the latter being dissolved either in an aqueous solvent or in an organic solvent or micro-emulsion. It should be appreciated that superficial coating of the wood with the active ingredient is not sufficient to achieve long-term protection, and therefore the invention is meant to relate to the in-depth impregnation of the wood with said active material. The actual depth of penetration of the active material will depend on many factors, as will be apparent to the skilled person, such as the type of wood or wood product, the type of solution, the pressure employed, etc. However, the invention encompasses all cases in which at least some impregnation of the wood, below the surface, is achieved.

### DETAILED DESCRIPTION OF THE INVENTION

The aforementioned characteristics and advantages of the invention will be better understood through the following illustrative and non-limitative examples of preferred embodiments thereof.

### EXAMPLE 1

Method

The termiticidal and/or termite repellency effect of TBBA was examined by field exposure of TBBA treated timber samples to an active population of termites (Macrotermes natalensis). Much of the test detail (timber specimen species, dimensions, preservative impregnation method, scoring system etc.) was based on the European laboratory standard EN 117. This standard is used to define the toxic values of wood preservative formulations against wood destroying termites of the species Reticulitermes santonensis.

The TBBA active was formulated as a solvent-borne product for the test. (ethanol carrier). The precise preservative solutions used were 0% (ethanol only), 1% TBBA, 3% TBBA, 5% TBBA, 7% TBBA and 10% TBBA (all w/w).

AU wood block specimens were of Scots pine sapwood (Pinus sylvestris) with dimensions of 50×25×15 mm. All the test blocks were vacuum impregnated with TBBA according to the method of EN 117. Distribution of the treated blocks in the test was as follows:

Treated Specimens (TS):

3 (replicate specimens)×5 (TBBA conc.s)=15 (no.s 34-48)

Solvent Control Specimens (SCS):

3 (replicate specimens)×1 (conc. (i.e. 0% (ethanol only))=3 (no.s 49-51)

Untreated Control Specimens (UCS) (Virulence): =3 (no.s 70-72)

TS Specimens: to determine the efficacy of the TBBA active (at different concentrations) against termite attack. SCS Specimens: to confirm absence of a termiticidal effect by the TBBA carrier (ethanol). UCS Specimens: to establish the virulence of the field population of termites.

The termite field site was established in Ginginglovu (Zululand, South Africa). The soil type of the area was a Hutton Bush Veldt soil (sandy loam soil). The site was situated within 10 m of an active termite mound on a raised flat platform of soil established some 5 cm above ground level. The test specimens were randomly positioned on this platform and carefully covered with a waterproof flat plastic roof. This plastic roof was covered with soil to allow temperature and humidity conditions within the test zone to remain representative of the locale. The test specimens were left in-situ for a period of 54 days then scored for termite attack according the system defined in European standard EN 117 as follows:

Score 0: No attack

Score 1: Attempted attack

Score 2: Slight attack

Score 3: Average attack

Score 4: Strong attack

Results

Table I displays mean termite attack scores (and high scores) for TBBA treated test specimens (ethanol carrier) after 54 days exposure to a field population of the termite Macrotermes natalensis. Table II displays mean termite attack scores (and high scores) for untreated virulence control specimens after 54 days exposure to a field population of the termite Macrotermes natalensis. In both tables, standard deviations are presented in the first parenthesis and the second parenthesis shows the highest score out of 3 replicates.

Table II shows a mean score of 2.67 (high score of 3) clearly indicating that the termite population at the site was very active and virulent. Table I shows that after 54 days exposure, of wood block specimens treated with solvent-borne TBBA at concentrations of 1%, 3%, 5%, 7% and 10%, only 1 block (of 3) treated with 7% had received any form of attack. The results for blocks treated with solvent only were severely attacked, indicating that the preservative carrier provided no protection. Under the scoring conditions of EN 117 therefore, the results indicate that the toxic values of solvent borne TBBA against termite attack lie between 1% and 10%.

TABLE I

| TBBA | Treated | Mean Termite |
|---|---|---|
| Concentrations | Specimen | Attack Score |
| studied (%) | Numbers | (0-4) |
| 10 | 34-36 | 0.00 (0.00) (0) |
| 7 | 37-39 | 0.33 (0.58) (1) |
| 5 | 40-42 | 0.00 (0.00) (0) |
| 3 | 43-45 | 0.00 (0.00) (0) |
| 1 | 46-48 | 0.00 (0.00) (0) |
| 0 | 49-51 | 2.33 (0.58) (3) |

TABLE II

| Treated | Mean Termite |
|---|---|
| Specimen | Attack Score |
| Numbers | (0-4) |
| 70-72 | 2.67 (0.58) (3) |

### EXAMPLE 2

Method

A laboratory test was undertaken to determine the toxic values of novel actives against termites. The active materials used were TBBA, TBBE [4,4′-ethylidenebis(2,6-dibromophenol)] [CAS RN=12639-25-3] (Sample Number 1392-82-03); TBBZ [4,4′-cyclohexylidene(2,6-dibromophenol)] [CAS RN=53350-96-2] (Sample Number 1392-72-03) and TBA, 2,2′,6-tribromo-4,4′-isopropylidenediphenol, CAS 6386-73-8 (Sample Number 1392-75-03).

The test was undertaken largely according to the strictures laid down in ASTM 3345-74 (the American standard laboratory test to assess the termite resistant properties of wood to wood destroying termites). The test method allows for the exposure of treated buried wood blocks to termites (Reticulitermes or Coptotermes spp.) over a period of 4 weeks. Efficacy of the product is determined by the extent of termite damage to the treated timber specimens through a scoring system. The test was slightly modified from the standard ASTM test by reducing the number of replicate wood specimens from 5 to 4. In addition, the ASTM scoring system was replaced by the more objective scoring system of the similar European standard EN 117 as follows:

Score 0: No attack

Score 1: Attempted attack

Score 2: Slight attack

Score 3: Average attack

Score 4: Strong attack

The toxic values of the preservative product (in kg/m³ of wood) fall between two values as follows:

1) The lowest concentration which protects the wood (i.e. the concentration at which none of the test specimens show a degree of attack greater than 1).

2) The next lowest concentration in the series used at which the wood is no longer sufficiently protected (i.e. the concentration at which at least one test specimen shows a degree of attack of 2 or greater).

The validity of the test is confirmed if at least 2 of the untreated control specimens and at least 2 of the solvent/diluent control specimens correspond to a damage score of 4, and the corresponding colonies have at least 50% survivors.

The termites employed were Coptotermes formosanus.

The treatment solutions tested were:

TBBA (Ethanol Carrier): 10%, 7%, 5%, 3% and 1%

TBBE (Ethanol Carrier): 10%, 7%, 5%, 3% and 1%

TBBZ (Ethanol Carrier): 10%, 7%, 5%, 3% and 1%

TBA (Ethanol Carrier): 10%, 7%, 5%, 3% and 1%

Ethanol Control

All wood bock specimens were of Southern Yellow Pine sapwood (Pinus spp.) with dimensions of 25.4×25.4×6.4 mm in accordance with ASTM D3345-74. All blocks were vacuum impregnated with the relevant solutions in accordance with ASTM D3345-74. Distribution of blocks in the test was as follows:

TBBA: 4 (specimens)×5 (conc.)=20 (block no.s 21-40)

TBBE: 4 (specimens)×5 (conc.)=20 (block no.s 61-80)

TBBZ: 4 (specimens)×5 (conc.)=20 (block no.s 81-100)

TBA: 4 (specimens)×5 (conc.)=20 (block no.s 101-120)

Ethanol Control: 4 (specimens)=4 (block no.s 181-184)

Ethanol controls were used to establish both the absence of any termicidal effect due to the ethanol carrier and the virulence of the termites used in the test.

The test specimens were conditioned and subjected to a leaching schedule (after vacuum impregnation) as stipulated in ASTM D1413-76 (as recommended in ASTM D3345-74). All test specimens were then air dried for two weeks to constant weight.

The specimens were each positioned at the base of a 500 ml polyethylene culture jar (numbered according to each test specimen) and covered with 200 g of sand (pre-washed, sterilised and air conditioned in the laboratory) to which was added 25 g of de-ionised water. A further two containers containing watered sand but no timber were also prepared. All the jars were sealed (lids pre-pierced and covered with stainless steel mesh for aeration).

Two days after specimen placement, 200 termites were added to each culture jar (90% workers and 10% soldiers) and the jars re-sealed. The jars were incubated at a mean temperature and relative humidity of 27.5° C. and 75-90% for 4 weeks. The containers were provided with an artificial lighting regime of 10 hours light and 14 hours darkness.

After 1 week and 4 weeks each container was examined to determine termite mortality and normal tunneling behaviour patterns as follows:

Is there tunneling present: YES/NO

Are there any termites on the surface of the soil: YES/NO (if yes how many, i.e. 1-25% of pop, 26-50% of pop, 51-100% of pop.)

Are any dead termites visible: YES/NO (if yes how many, 1-33%, 34-66%, 67-100%)

After 4 weeks the test specimens were removed and cleaned of debris. Each block was examined and visually rated for termite damage using the scoring system detailed above.

Results

Table III shows termite attack ratings on wood specimens treated with ethanol after 4 weeks incubation in sand culture.

Tables IV, V, VI and VII show termite attack ratings on wood specimens treated with TBBA, TBBE, TBBZ and TBA respectively, after 4 weeks incubation in sand culture.

Table IIa shows tunneling activity, surface activity and mortality of termites after 1 and 4 weeks exposure in sand culture to wood specimens treated with ethanol.

Tables IVa, Va, VIIa and VIIa show tunneling activity, surface activity and mortality of termites after 1 and 4 weeks exposure in sand culture to wood specimens treated with TBBA, TBBE, TBBZ and TBA respectively.

Ethanol Specimens: Table m shows that the termites used in the test were virulent (and were not affected by ethanol treatment of these specimens) with 2 of the 4 test specimens suffering strong attack. This was to be expected as table IIIa shows that the termites thrived under the test conditions with tunneling activity and complete survival noted throughout the test period.

TBBA Specimens: Table IV shows that the toxic values of TBBA are 32.52 and 44.00 kg/m³ (solution concentrations of 5 and 7%). The score of 2 for one of the test specimens, at a mean loading of 55.26 kg/m³, is disregarded as an anomalous result. The surface activity data in table IVa indicates that the two highest TBBA concentrations (7 and 10%) resulted in a degree of termite repellency throughout the incubation period. In addition, the three highest concentrations (5, 7 and 10%) resulted in very significant termite mortality (generally 67-100%) by the end of the incubation period.

TBBE Specimens: Table V shows that the toxic values of TBBE are 28.53 and 35.93 kg/M³ (solution concentrations of 5 and 7%). The surface activity noted in table Va indicates that TBBE provided a repellent effect at certain stages of the incubation period. The highest concentration of TBBE (10%) resulted in 67-100% termite mortality by the end of the incubation period.

TBBZ Specimens: The presence of individual ratings of 2 at the three highest concentrations prevented the determination of toxic values for this active (Table VI). However, it is clear that the higher concentrations do reduce termite attack. TBBE also provided a repellent effect early in the incubation period at higher concentrations and resulted in significant termite mortality by the end of the incubation period (table VIa).

TBA Specimens: Table VII shows that the toxic values of TBA are 30.17 and 41.22 kg/m³ (solution concentrations of 5 and 7%). TBA produced no repellent effect on the termite population but the higher concentrations resulted in 34-66% termite mortality by the end of the incubation period (table VIIa).

TABLE III

| | Termite Attack | Mean |
|---|---|---|
| Specimen No. | Rating | Rating |
| 181 | 3 | 3.50 |
| 182 | 4 | (0.58) |
| 183 | 4 | |
| 184 | 3 | |

TABLE IV

| | | | | Termite | |
|---|---|---|---|---|---|
| Specimen | Solution | Loading | Mean | Attack | Mean |
| No. | Conc. (%) | (kg/m³) | (kg/m³) | Rating | Rating |
| 21 | 10 | 48.0565 | 54.28 | 1 | 1.00 |
| 22 | 10 | 56.3233 | (4.95) | 1 | (0.00) |
| 23 | 10 | 59.6759 | | 1 | |
| 24 | 10 | 53.0682 | | 1 | |
| 25 | 7 | 39.6153 | 35.93 | 1 | 1.00 |
| 26 | 7 | 35.6604 | (2.70) | 1 | (0.00) |
| 27 | 7 | 33.1234 | | 1 | |
| 28 | 7 | 35.3348 | | 1 | |
| 29 | 5 | 30.0848 | 28.53 | 1 | 1.50 |
| 30 | 5 | 28.1562 | (2.39) | 1 | (0.58) |
| 31 | 5 | 25.3130 | | 2 | |
| 32 | 5 | 30.5730 | | 2 | |
| 33 | 3 | 17.7648 | 17.78 | 2 | 2.25 |
| 34 | 3 | 16.4121 | (1.11) | 2 | (0.50) |
| 35 | 3 | 17.8172 | | 3 | |
| 36 | 3 | 19.1350 | | 2 | |
| 37 | 1 | 7.5465 | 6.94 | 3 | 2.75 |
| 38 | 1 | 6.8405 | (0.41) | 2 | (0.95) |
| 39 | 1 | 6.6395 | | 4 | |
| 40 | 1 | 6.7444 | | 2 | |

TABLE V

| | | | | Termite | |
|---|---|---|---|---|---|
| Specimen | Solution | Loading | Mean | Attack | Mean |
| No. | Conc. (%) | (kg/m³) | (kg/m³) | Rating | Rating |
| 61 | 10 | 51.7924 | 55.26 | 1 | 1.25 |
| 62 | 10 | 59.9261 | (5.35) | 1 | (0.50) |
| 63 | 10 | 49.5835 | | 1 | |
| 64 | 10 | 59.7234 | | 2 | |
| 65 | 7 | 42.7084 | 44.00 | 1 | 1.00 |
| 66 | 7 | 46.2477 | (1.77) | 1 | (0.00) |
| 67 | 7 | 42.4744 | | 1 | |
| 68 | 7 | 44.5619 | | 1 | |
| 69 | 5 | 33.4407 | 32.52 | 2 | 1.50 |
| 70 | 5 | 30.9586 | (1.11) | 1 | (0.58) |
| 71 | 5 | 33.1791 | | 1 | |
| 72 | 5 | 32.5056 | | 2 | |
| 73 | 3 | 17.1295 | 17.94 | 2 | 2.00 |
| 74 | 3 | 17.4279 | (1.12) | 2 | (0.82) |
| 75 | 3 | 17.6150 | | 3 | |
| 76 | 3 | 19.5934 | | 1 | |
| 77 | 1 | 5.7355 | 5.62 | 3 | 3.00 |
| 78 | 1 | 5.8468 | (0.23) | 3 | (0.00) |
| 79 | 1 | 5.5676 | | 3 | |
| 80 | 1 | 5.3174 | | 3 | |

NB: 0: No Attack/1: Attempted Attack/2: Slight Attack/3: Average Attack/4: Strong Attack

TABLE VI

| | | | | Termite | |
|---|---|---|---|---|---|
| Specimen | Solution | Loading | Mean | Attack | Mean |
| No. | Conc. (%) | (kg/m³) | (kg/m³) | Rating | Rating |
| 81 | 10 | 56.1953 | 56.09 | 1 | 1.25 |
| 82 | 10 | 56.5116 | (0.34) | 1 | (0.50) |
| 83 | 10 | 55.8560 | | 1 | |
| 84 | 10 | 55.7841 | | 2 | |
| 85 | 7 | 37.8957 | 39.36 | 1 | 1.25 |
| 86 | 7 | 35.8088 | (3.17) | 1 | (0.50) |
| 87 | 7 | 43.1990 | | 2 | |
| 88 | 7 | 40.1507 | | 1 | |
| 89 | 5 | 29.1654 | 28.54 | 1 | 1.25 |
| 90 | 5 | 30.1080 | (1.47) | 1 | (0.50) |
| 91 | 5 | 28.2496 | | 1 | |
| 92 | 5 | 26.6558 | | 2 | |
| 93 | 3 | 18.8209 | 16.96 | 2 | 1.50 |
| 94 | 3 | 18.9218 | (2.40) | 1 | (0.58) |
| 95 | 3 | 13.8822 | | 2 | |
| 96 | 3 | 16.2365 | | 1 | |
| 97 | 1 | 5.6620 | 5.95 | 4 | 2.50 |
| 98 | 1 | 5.0941 | (0.71) | 2 | (1.00) |
| 99 | 1 | 6.4104 | | 2 | |
| 100 | 1 | 6.6534 | | 2 | |

NB: 0: No Attack/1: Attempted Attack/2: Slight Attack/3:Average Attack/4: Strong Attack

TABLE VII

| | | | | Termite | |
|---|---|---|---|---|---|
| Specimen | Solution | Loading | Mean | Attack | Mean |
| No. | Conc. (%) | (kg/m³) | (kg/m³) | Rating | Rating |
| 101 | 10 | 62.5923 | 55.10 | 1 | 1.00 |
| 102 | 10 | 56.2025 | (6.25) | 1 | (0.00) |
| 103 | 10 | 54.1902 | | 1 | |
| 104 | 10 | 47.4157 | | 1 | |
| 105 | 7 | 40.2913 | 41.22 | 1 | 1.00 |
| 106 | 7 | 37.8605 | (2.84) | 1 | (0.00) |
| 107 | 7 | 44.5498 | | 1 | |
| 108 | 7 | 42.1750 | | 1 | |
| 109 | 5 | 29.4314 | 30.17 | 2 | 1.75 |
| 110 | 5 | 31.2399 | (0.78) | 1 | (0.50) |
| 111 | 5 | 30.1471 | | 2 | |
| 112 | 5 | 29.8682 | | 2 | |
| 113 | 3 | 17.8751 | 18.41 | 2 | 1.75 |
| 114 | 3 | 18.3913 | (1.71) | 2 | (0.50) |
| 115 | 3 | 20.7329 | | 1 | |
| 116 | 3 | 16.6446 | | 2 | |
| 117 | 1 | 5.2534 | 5.82 | 3 | 3.00 |
| 118 | 1 | 6.1841 | (0.58) | 2 | (0.82) |
| 119 | 1 | 5.3939 | | 3 | |
| 120 | 1 | 6.4328 | | 4 | |

TABLE IIIa

| | Tunneling | Surface | Visible |
|---|---|---|---|
| Specimen | Activity | Activity | Mortality |
| No. | (1 week) | (1 week) | (1 week) |
| 181 | Yes | No | No |
| 182 | Yes | No | No |
| 183 | Yes | No | No |
| 184 | Yes | No | No |
| | Tunneling | Surface | Visible |
| Specimen | Activity | Activity | Mortality |
| No. | (4 weeks) | (4 weeks) | (4 weeks) |
| 181 | Yes | No | No |
| 182 | Yes | No | No |
| 183 | Yes | No | No |
| 184 | Yes | No | No |

TABLE IVa

| | Tunneling | Surface | Visible |
|---|---|---|---|
| Specimen | Activity (¼ | Activity (¼ | Mortality (¼ |
| No. | weeks) | weeks) | weeks) |
| 21 | Yes/Yes | No/1-25% (of pop.) | No/67-100% (of |
| | | | pop.) |
| 22 | Yes/Yes | No/1-25% (of pop.) | No/67-100% (of |
| | | | pop.) |
| 23 | Yes/Yes | No/1-25% (of pop.) | No/67-100% (of |
| | | | pop.) |
| 24 | Yes/Yes | No/1-25% (of pop.) | No/67-100% (of |
| | | | pop.) |
| 25 | Yes/Yes | No/No | No/1-33% (of pop.) |
| 26 | Yes/Yes | No/No | No/1-33% (of pop.) |
| 27 | Yes/Yes | No/No | No/1-33% (of pop.) |
| 28 | Yes/Yes | No/No | No/1-33% (of pop.) |
| 29 | Yes/Yes | 1-25%/No (of pop.) | 1-33%/1-33% (of |
| | | | pop.) |
| 30 | Yes/Yes | 1-25%/No (of pop.) | 1-33%/1-33% (of |
| | | | pop.) |
| 31 | Yes/Yes | 1-25%/No (of pop.) | No/1-33% (of pop.) |
| 32 | Yes/Yes | 1-25%/No (of pop.) | No/1-33% (of pop.) |
| 33 | Yes/Yes | No/No | No/1-33% (of pop.) |
| 34 | Yes/Yes | No/No | No/1-33% (of pop.) |
| 35 | Yes/Yes | No/No | No/No |
| 36 | Yes/Yes | No/No | No/No |
| 37 | Yes/Yes | No/No | No/No |
| 38 | Yes/Yes | No/No | No/No |
| 39 | Yes/Yes | No/No | No/No |
| 40 | Yes/Yes | No/No | No/No |

TABLE Va

| | Tunneling | Surface | Visible |
|---|---|---|---|
| Specimen | Activity (¼ | Activity (¼ | Mortality (¼ |
| No. | weeks) | weeks) | weeks) |
| 61 | Yes/Yes | 1-25%/1-25% (of | No/67-100% (of |
| | | pop.) | pop.) |
| 62 | Yes/Yes | 1-25%/1-25% (of | No/67-100% (of |
| | | pop.) | pop.) |
| 63 | Yes/Yes | 1-25%/1-25% (of | No/67-100% (of |
| | | pop.) | pop.) |
| 64 | Yes/Yes | 1-25%/1-25% (of | No/67-100% (of |
| | | pop.) | pop.) |
| 65 | Yes/Yes | 1-25%/1-25% (of | No/67-100% (of |
| | | pop.) | pop.) |
| 66 | Yes/Yes | 1-25%/1-25% (of | No/67-100% (of |
| | | pop.) | pop.) |
| 67 | Yes/Yes | 1-25%/1-25% (of | 1-33%/67-100% (of |
| | | pop.) | pop.) |
| 68 | Yes/Yes | 1-25%/1-25% (of | No/67-100% (of |
| | | pop.) | pop.) |
| 69 | Yes/Yes | No/No | No/67-100% (of |
| | | | pop.) |
| 70 | Yes/Yes | No/No | No/67-100% (of |
| | | | pop.) |
| 71 | Yes/Yes | No/No | No/34-66% (of pop.) |
| 72 | Yes/Yes | No/No | No/1-33% (of pop.) |
| 73 | Yes/Yes | No/No | No/1-33% (of pop.) |
| 74 | Yes/Yes | No/No | No/1-33% (of pop.) |
| 75 | Yes/Yes | No/No | No/1-33% (of pop.) |
| 76 | Yes/Yes | No/No | No/1-33% (of pop.) |
| 77 | Yes/Yes | No/No | No/No |
| 78 | Yes/Yes | No/No | No/No |
| 79 | Yes/Yes | No/No | No/No |
| 80 | Yes/Yes | No/No | No/No |

TABLE VIa

| | Tunneling | Surface | Visible |
|---|---|---|---|
| | Activity | Activity | Mortality |
| Specimen | (¼ | (¼ | (¼ |
| No. | weeks) | weeks) | weeks) |
| 81 | Yes/Yes | 1-25%/No (of pop.) | No/67-100% (of |
| | | | pop.) |
| 82 | Yes/Yes | 1-25%/No (of pop.) | No/67-100% (of |
| | | | pop.) |
| 83 | Yes/Yes | 1-25%/No (of pop.) | No/67-100% (of |
| | | | pop.) |
| 84 | Yes/Yes | 1-25%/No (of pop.) | No/67-100% (of |
| | | | pop.) |
| 85 | Yes/Yes | 1-25%/No (of pop.) | No/34-66% (of pop.) |
| 86 | Yes/Yes | 1-25%/No (of pop.) | No/34-66% (of pop.) |
| 87 | Yes/Yes | 1-25%/No (of pop.) | No/34-66% (of pop.) |
| 88 | Yes/Yes | 1-25%/No (of pop.) | No/34-66% (of pop.) |
| 89 | Yes/Yes | No/No | No/34-66% (of pop.) |
| 90 | Yes/Yes | No/No | No/34-66% (of pop.) |
| 91 | Yes/Yes | No/No | No/34-66% (of pop.) |
| 92 | Yes/Yes | No/No | No/34-66% (of pop.) |
| 93 | Yes/Yes | No/No | No/1-33% (of pop.) |
| 94 | Yes/Yes | No/No | No/1-33% (of pop.) |
| 95 | Yes/Yes | No/No | No/1-33% (of pop.) |
| 96 | Yes/Yes | No/No | No/1-33% (of pop.) |
| 97 | Yes/Yes | No/No | No/No |
| 98 | Yes/Yes | No/No | No/No |
| 99 | Yes/Yes | No/No | No/No |
| 100 | Yes/Yes | No/No | No/No |

TABLE VIIa

| | Tunneling | Surface | Visible |
|---|---|---|---|
| Specimen | Activity (¼ | Activity (¼ | Mortality (¼ |
| No. | weeks) | weeks) | weeks) |
| 101 | Yes/Yes | No/No | No/34-66% (of pop.) |
| 102 | Yes/Yes | No/No | No/34-66% (of pop.) |
| 103 | Yes/Yes | No/No | No/34-66% (of pop.) |
| 104 | Yes/Yes | No/No | No/34-66% (of pop.) |
| 105 | Yes/Yes | No/No | No/34-66% (of pop.) |
| 106 | Yes/Yes | No/No | No/34-66% (of pop.) |
| 107 | Yes/Yes | No/No | No/34-66% (of pop.) |
| 108 | Yes/Yes | No/No | No/34-66% (of pop.) |
| 109 | Yes/Yes | No/No | No/34-66% (of pop.) |
| 110 | Yes/Yes | No/No | No/34-66% (of pop.) |
| 111 | Yes/Yes | No/No | No/34-66% (of pop.) |
| 112 | Yes/Yes | No/No | No/34-66% (of pop.) |
| 113 | Yes/Yes | No/No | No/1-33% (of pop.) |
| 114 | Yes/Yes | No/No | No/1-33% (of pop.) |
| 115 | Yes/Yes | No/No | No/1-33% (of pop.) |
| 116 | Yes/Yes | No/No | No/1-33% (of pop.) |
| 117 | Yes/Yes | No/No | No/No |
| 118 | Yes/Yes | No/No | No/No |
| 119 | Yes/Yes | No/No | No/No |
| 120 | Yes/Yes | No/No | No/No |

From the reported results, the following conclusions may, inter alia, be reached:

1) Impregnation of test specimens with concentrated solutions of TBBA, TBBE, TBBZ and TBA, followed by leaching, resulted in a significant reduction in termite attack.

2) Impregnation of test specimens with concentrated solutions of TBBA, TBBE and TBBZ resulted in a degree of termite repellency and the highest treatment concentrations of TBBA, TBBE, TBBZ and TBA generally resulted in 67-100% mortality of the termite population by the end of the trial.

### EXAMPLE 3

Method

A further experiment was undertaken according to the modified ASTM 3345-74 test detailed in Example 2 with the following 6 changes to the protocol:

1. The solutions tested were as follows:

TBBA (NaOH Carrier): 10%, 7%, 5%, 3% and 1%

TBBF (NaOH Carrier): 10%, 7%, 5%, 3% and 1%

TBBS (NaOH Carrier): 10%, 7%, 5%, 3% and 1%

NaOH Carrier Control: 10%, 7%, 5%, 3% and 1%

H₂O Control

Untreated Control

2. The incubation substrate was a soil/sand mixture (1:1) to which had been added 75 ml of de-ionised water. This substrate was chosen as being more representative of the laboratory conditions under which the wild caught termites (C. formosanus) were maintained.

3. The treated timber samples were positioned on plastic mesh on top of the soil substrate. This method of placement is that used in European Standard EN 117 and is more representative of the feeding conditions of the wild caught termites maintained in the laboratory.

4. 250 termites were used in each incubation vessel.

5. The wood block specimens were not subjected to a leaching process.

6. Evidence of termite tunneling activity and mortality was determined at completion of the incubation period only (4 weeks) and no examinations were undertaken for surface activity.

Distribution of blocks in the test was as follows:

TBBA: 4 (specimens)×5 (conc.)=20 (block no.s 41-60)

TBBF: 4 (specimens)×5 (conc.)=20 (block no.s 121-140)

TBBS: 4 (specimens)×5 (conc.)=20 (block no.s 141-160)

NaOH Carrier Control: 1 (specimen)×5 (conc.)=5 (blocks 163/165/172/174/179)

H₂O Control: 4 (specimens)=4 (block no.s 185-188)

Untreated Control: 4 (specimens)=4 (block no.s 189-192)

NaOH Carrier, H₂O and untreated controls were used to establish both the absence of any termiticidal effect due to the NaOH carrier solution and the virulence of the termites used in the test.

Results

Table VIII shows termite attack ratings on untreated wood specimens after 4 weeks incubation in soil/sand culture.

Table IX shows termite attack ratings on wood specimens treated with de-ionised water after 4 weeks incubation in soil/sand culture.

Tables X, XI and XII show termite attack ratings on wood specimens treated with TBBA, TBBF and TBBS respectively, after 4 weeks incubation in soil/sand culture.

Table XIII shows termite attack ratings on wood specimens treated with NaOH carrier solutions after 4 weeks incubation in soil/sand culture.

Table VIIIa shows tunneling activity and mortality of termites after 4 weeks exposure in soil/sand culture to untreated wood specimens.

Table IXa shows tunneling activity and mortality of termites after 4 weeks exposure in soil/sand culture to wood specimens treated with de-ionised water.

Tables Xa, XIa and XIIa show tunneling activity and mortality of termites after 4 weeks exposure in soil/sand culture to wood specimens treated with TBBA, TBBF and TBBS respectively.

Table XIIa shows tunneling activity and mortality of termites after 4 weeks exposure in soil/sand culture to wood specimens treated with NaOH carrier solutions.

Control Specimens: Tables VII and IX (untreated and water treated specimens) show that the termites used in the test were highly virulent with 3 of the 8 test specimens suffering the highest level of attack according to the rating system. In addition, Table XIII shows that none of the NaOH control specimens, except that treated with the highest concentration of NaOH, escaped the highest level of attack. Tables VIIa, IXa and XIIIa show that the high level of attack experienced by all the foregoing test specimens was clearly due to the test conditions favoring termite survival with the great majority of the termites active at the end of the test period.

TBBA Specimens: Table X shows that the upper mean toxic value of TBBA, according to these test results, was 6.97 kg/m⁸ (solution concentration of 1%). The data indicate that significant attack was prevented by all concentrations of TBBA used. Despite this low level of attack, table Xa shows that the majority of the termites were still active at the end of the test period. TBBA appeared therefore to be acting as a repellent throughout the trial period. This is supported by the observation that the termites had only partially soil covered those test specimens treated with 5, 7 and 10% solutions of TBBA, while those specimens treated with the lower concentrations were invariably completely covered.

TBBF Specimens: Table XI shows that the toxic values of TBBF are 6.78 and 20.53 kg/m³ (solution concentrations of 1 and 3%). The data again indicate that significant attack was prevented by all concentrations of TBBF used. Table XIa shows that the majority of the termites were killed by the end of the test period indicating a significant termiticidal effect. However, as was found for TBBA, those test specimens treated with 5, 7 and 10% solutions of TBBF were only partially soil covered at the end of the test, thereby demonstrating a repellent effect also.

TBBS Specimens: Table XII shows that the upper mean toxic value of TBBA, according to these test results, was 7.27 kg/M³ (solution concentration of 1%). As shown for both TBBA and TBBF, significant attack was prevented by all concentrations of TBBS used. Table XIIa shows that exposure to TBBS resulted in significant termite mortality by the end of the test period. Once more a repellent effect was noted with test specimens treated with 5, 7 and 10% solutions of TBBS being partially soil covered at the end of the test.

TABLE VIII

| | Termite Attack | Mean |
|---|---|---|
| Specimen No. | Rating | Rating |
| 189 | 4 | 2.75 |
| 190 | 2 | (0.96) |
| 191 | 3 | |
| 192 | 2 | |

TABLE IX

| | | |
|---|---|---|
| | Termite Attack | Mean |
| Specimen No. | Rating | Rating |

| | | |
|---|---|---|
| 185 | 4 | 3.00 |
| 186 | 2 | (1.15) |
| 187 | 4 | |
| 188 | 2 | |

TABLE X

| | | | | Termite | |
|---|---|---|---|---|---|
| Specimen | Solution | Loading | Mean | Attack | Mean |
| No. | Conc. (%) | (kg/m³) | (kg/m³) | Rating | Rating |
| 41 | 10 | 74.6900 | 71.14 | 1 | 1.00 |
| 42 | 10 | 65.7449 | (3.86) | 1 | (0.00) |
| 43 | 10 | 71.2935 | | 1 | |
| 44 | 10 | 72.8397 | | 1 | |
| 45 | 7 | 49.5152 | 51.69 | 1 | 0.75 |
| 46 | 7 | 54.1000 | (1.88) | 1 | (0.50) |
| 47 | 7 | 51.5702 | | 0 | |
| 48 | 7 | 51.5850 | | 1 | |
| 49 | 5 | 35.8990 | 36.78 | 1 | 1.00 |
| 50 | 5 | 36.4348 | (1.19) | 1 | (0.00) |
| 51 | 5 | 36.2667 | | 1 | |
| 52 | 5 | 38.5379 | | 1 | |
| 53 | 3 | 20.9089 | 22.40 | 1 | 1.00 |
| 54 | 3 | 23.6298 | (1.18) | 1 | (0.00) |
| 55 | 3 | 22.0586 | | 1 | |
| 56 | 3 | 22.9877 | | 1 | |
| 57 | 1 | 7.1182 | 6.97 | 1 | 1.00 |
| 58 | 1 | 7.1204 | (0.33) | 1 | (0.00) |
| 59 | 1 | 7.1712 | | 1 | |
| 60 | 1 | 6.4710 | | 1 | |

NB: 0: No Attack/1: Attempted Attack/2: Slight Attack/3: Average Attack/4: Strong Attack

TABLE XI

| | | | | Termite | |
|---|---|---|---|---|---|
| Specimen | Solution | Loading | Mean | Attack | Mean |
| No. | Conc. (%) | (kg/m³) | (kg/m³) | Rating | Rating |
| 121 | 10 | 61.1175 | 56.07 | 1 | 0.5 |
| 122 | 10 | 54.6652 | (5.21) | 0 | (0.58) |
| 123 | 10 | 49.3758 | | 0 | |
| 124 | 10 | 59.1172 | | 1 | |
| 125 | 7 | 45.6618 | 38.61 | 1 | 0.75 |
| 126 | 7 | 37.4983 | (5.62) | 0 | (0.50) |
| 127 | 7 | 32.0221 | | 1 | |
| 128 | 7 | 39.2380 | | 1 | |
| 129 | 5 | 25.7958 | 29.91 | 0 | 0.5 |
| 130 | 5 | 33.5691 | (3.20) | 0 | (0.58) |
| 131 | 5 | 30.5580 | | 1 | |
| 132 | 5 | 29.7245 | | 1 | |
| 133 | 3 | 21.1138 | 20.53 | 0 | 0.75 |
| 134 | 3 | 22.3233 | (1.61) | 1 | (0.50) |
| 135 | 3 | 20.1881 | | 1 | |
| 136 | 3 | 18.4960 | | 1 | |
| 137 | 1 | 7.0290 | 6.78 | 3 | 1.50 |
| 138 | 1 | 6.6132 | (0.51) | 1 | (1.00) |
| 139 | 1 | 6.1630 | | 1 | |
| 140 | 1 | 7.3321 | | 1 | |

NB: 0: No Attack/1: Attempted Attack/2: Slight Attack/3: Average Attack/4: Strong Attack

TABLE XII

| | | | | Termite | |
|---|---|---|---|---|---|
| Specimen | Solution | Loading | Mean | Attack | Mean |
| No. | Conc. (%) | (kg/m³) | (kg/m³) | Rating | Rating |
| 141 | 10 | 66.4361 | 68.25 | 0 | 0.25 |
| 142 | 10 | 59.5467 | (6.98) | 0 | (0.50) |
| 143 | 10 | 75.9517 | | 0 | |
| 144 | 10 | 71.0662 | | 1 | |
| 145 | 7 | 55.0388 | 48.81 | 1 | 0.75 |
| 146 | 7 | 45.9981 | (7.61) | 1 | (0.50) |
| 147 | 7 | 39.3169 | | 0 | |
| 148 | 7 | 54.8711 | | 1 | |
| 149 | 5 | 31.9904 | 34.70 | 1 | 1.00 |
| 150 | 5 | 34.6792 | (1.96) | 1 | (0.00) |
| 151 | 5 | 35.5325 | | 1 | |
| 152 | 5 | 36.5564 | | 1 | |
| 153 | 3 | 19.4698 | 20.11 | 1 | 0.5 |
| 154 | 3 | 21.3925 | (1.71) | 0 | (0.58) |
| 155 | 3 | 21.5804 | | 0 | |
| 156 | 3 | 17.9846 | | 1 | |
| 157 | 1 | 7.2622 | 7.25 | 1 | 1.00 |
| 158 | 1 | 6.7354 | (0.48) | 1 | (0.00) |
| 159 | 1 | 7.8894 | | 1 | |
| 160 | 1 | 7.1311 | | 1 | |

NB: 0: No Attack/1: Attempted Attack/2: Slight Attack/3: Average Attack/4: Strong Attack

TABLE XIII

| Specimen | Solution Conc. | Termite |
|---|---|---|
| No. | (%) Eq. | Attack Rating |
| 163 | 10 | 1 |
| 165 | 7 | 4 |
| 172 | 5 | 4 |
| 174 | 3 | 4 |
| 179 | 1 | 4 |

NB: 0: No Attack/1: Attempted Attack/2: Slight Attack/3: Average Attack/4: Strong Attack

TABLE VIIIa

| Specimen | Tunneling | Visible |
|---|---|---|
| No. | Activity | Mortality |
| 189 | Yes | 1-33% |
| 190 | Yes | 1-33% |
| 191 | Yes | 1-33% |
| 192 | Yes | 1-33% |

TABLE IXa

| Specimen | Tunneling | Visible |
|---|---|---|
| No. | Activity | Mortality |
| 185 | Yes | 1-33% |
| 186 | Yes | 1-33% |
| 187 | Yes | 1-33% |
| 188 | Yes | 1-33% |

TABLE Xa

| Specimen | Tunneling | Visible |
|---|---|---|
| No. | Activity | Mortality |
| 41 | Yes | 1-33% |
| 42 | Yes | 1-33% |
| 43 | Yes | 1-33% |
| 44 | Yes | 1-33% |
| 45 | Yes | 1-33% |
| 46 | Yes | 1-33% |
| 47 | Yes | 1-33% |
| 48 | Yes | 1-33% |
| 49 | Yes | 1-33% |
| 50 | Yes | 1-33% |
| 51 | Yes | 1-33% |
| 52 | Yes | 1-33% |
| 53 | Yes | 1-33% |
| 54 | Yes | 1-33% |
| 55 | Yes | 1-33% |
| 56 | Yes | 1-33% |
| 57 | Yes | No |
| 58 | Yes | No |
| 59 | Yes | No |
| 60 | Yes | No |

TABLE XIa

| Specimen | Tunneling | Visible |
|---|---|---|
| No. | Activity | Mortality |
| 121 | Yes | 67-100% |
| 122 | Yes | 67-100% |
| 123 | Yes | 67-100% |
| 124 | Yes | 67-100% |
| 125 | Yes | 67-100% |
| 126 | Yes | 67-100% |
| 127 | Yes | 67-100% |
| 128 | Yes | 67-100% |
| 129 | Yes | 67-100% |
| 130 | Yes | 67-100% |
| 131 | Yes | 67-100% |
| 132 | Yes | 67-100% |
| 133 | Yes | 34-66% |
| 134 | Yes | 34-66% |
| 135 | Yes | 34-66% |
| 136 | Yes | 34-66% |
| 137 | Yes | 34-66% |
| 138 | Yes | 34-66% |
| 139 | Yes | 34-66% |
| 140 | Yes | 34-66% |

TABLE XIIa

| Specimen | Tunneling | Visible |
|---|---|---|
| No. | Activity | Mortality |
| 141 | Yes | 34-66% |
| 142 | Yes | 67-100% |
| 143 | Yes | 67-100% |
| 144 | Yes | 34-66% |
| 145 | Yes | 67-100% |
| 146 | Yes | 67-100% |
| 147 | Yes | 100% |
| 148 | Yes | 67-100% |
| 149 | Yes | 67-100% |
| 150 | Yes | 67-100% |
| 151 | Yes | 67-100% |
| 152 | Yes | 67-100% |
| 153 | Yes | 34-66% |
| 154 | Yes | 34-66% |
| 155 | Yes | 67-100% |
| 156 | Yes | 67-100% |
| 157 | Yes | 67-100% |
| 158 | Yes | 67-100% |
| 159 | Yes | 67-100% |
| 160 | Yes | 67-100% |

TABLE XIIIa

| Specimen | Tunneling | Visible |
|---|---|---|
| No. | Activity | Mortality |
| 163 | Yes | 1-33% |
| 165 | Yes | 1-33% |
| 172 | Yes | 1-33% |
| 174 | Yes | 1-33% |
| 179 | Yes | 1-33% |

From the results reported above the following conclusions can be reached. The test results for TBBA, TBBF and TBBS indicate a very significant effect in restricting termite damage to timber specimens treated with these actives.

TBBA, TBBF and TBBS all display significant termiticidal and termite repellent activity. Timber impregnated with these actives is protected against termite attack.

All the above description of preferred embodiments has been given for the purpose of illustration and is not meant to limit the invention. Many variations and modifications can be provided by the skilled person, all which are meant to be encompassed by the claims to follow.

1. An insecticidal and termiticidal wood preservative composition containing as an active ingredient a compound of the formula:
(I) 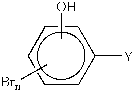
wherein y is a moiety selected from the group consisting of halogen, substituted aromatic ring and aliphatic residue, and n=1 to 4.

2. A composition according to claim 1, wherein Y is 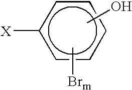
wherein X is a moiety selected from the group consisting of alkyl, S and SO₂, and m=0 to 4.

3. A composition according to claim 1, wherein the compound of Formula (I) is selected from the group consisting of tetrabromobisphenol A (TBBA), [4,4′-isopropylidenebis(2,6-dibromophenol)], tribromobisphenol A [2,2′,6-tribromo-4,4′-isopropylidenediphenol] (TBA) and a bromine derivative of a compound selected from the group consisting of:

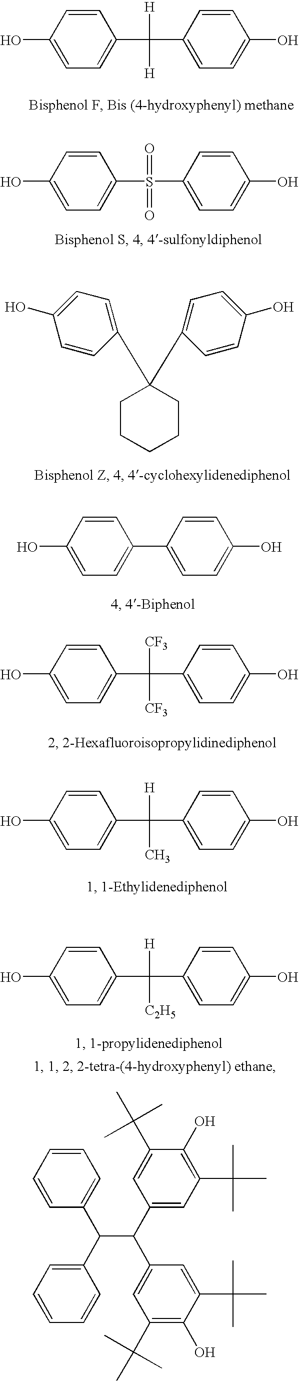

4. A composition according to claim 1, which is dissolved in a solvent.

5. A composition according to claim 4, wherein the solvent is ethanol.

6. A composition according to claim 4, wherein the solvent is an aqueous basic solution.

7. A composition according to claim 6, wherein the base is NaOH.

8. A composition according to claim 1, wherein the active material is TBBA and its concentration ranges between 1% (w/w) and 10% (w/w).

9. A composition according to claim 1, further comprising conventional termiticidal and insecticidal agents.

10. A method for protecting wood against termites, comprising impregnating the wood with a wood preservative composition according to claim 1.

11. Use of a composition according to claim 1, for protecting wood against termites.

12. A composition according to claim 1, for use as a termiticidal agent, alone or together with conventional termiticidal and/or insecticidal agents.
